(19) United States
(12) Patent Application Publication
(10) Pub. No.: US 2026/0357646 A1
(43) Pub. Date: Nov. 12, 2026

(54) APPARATUS FOR RETRIEVING, PICKING, AND PLACING SPACERS WHEN MAKING VACUUM INSULATED PANEL, AND METHOD WITH SAME

(71) Applicant: LuxWall, Inc., Ypsilanti, MI (US)

(72) Inventor: Maximo FRATI, Olive Branch, MS (US)

(21) Appl. No.: 19/199,450

(22) Filed: May 6, 2025

(51) Int. Cl. E06B 3/673; E06B 3/66

(52) U.S. Cl. CPC E06B 3/67326; E06B 3/6612

(57) ABSTRACT

A spacer retrieving, picking and placement apparatus, for use in making a vacuum insulated panel, may include a retractable slide for allowing spacers (e.g., pillars) to be picked up one-by-one and placed on a substrate in an appropriate manner during the manufacture of a vacuum insulating panel.

### FIELD

Certain example embodiments are generally related to vacuum insulated devices such as vacuum insulating panels that may be used for windows or the like. Certain example embodiments relate to an apparatus for retrieving and/or placing spacers (e.g., pillars) when making such a vacuum insulated device, and/or a method of making a vacuum insulated panel involving same.

### BACKGROUND AND SUMMARY

Vacuum insulated panels are known in the art. For example, and without limitation, vacuum insulating panels are disclosed in U.S. Pat. Nos. 5,124,185, 5,657,607, 5,664,395, 7,045,181, 7,115,308, 8,821,999, 10,153,389, 11,124,450, 2024/0167320, and 2024/0167324, the disclosures of which are all hereby incorporated herein by reference in their entireties.

As discussed and/or shown in one or more of the above patent documents, a vacuum insulating panel typically includes an outboard substrate, an inboard substrate, a hermetic edge seal, and spacers (e.g., pillars) sandwiched between at least the two substrates. The gap between the substrates may be at a pressure less than atmospheric pressure to provide insulating properties. Providing a vacuum in the space between the substrates reduces conduction and convection heat transport, and thus provides insulating properties. For example, a vacuum insulating panel may provide thermal insulation resistance by reducing convective energy between the two substrates, reducing conductive energy between the two transparent substrates, and reducing radiative energy with a low-emissivity (low-E) coating provided on a substrate. Vacuum insulating panels may be used in window applications (e.g., for commercial and/or residential windows), and/or for other applications such as commercial refrigeration and consumer appliance applications.

Spacers (e.g., pillars) for use in vacuum insulating panels are very small in size. Example spacers are described in U.S. Patent Document 2024/0167324 to Thomsen, incorporated herein by reference. For example, spacers may have a height of from about 150-400 μm. Spacers may be any suitable shape (e.g., round, oval, disc-shaped, square, rectangular, rod-shaped, etc.) and may be of or include any suitable material such as stainless steel, aluminum, ceramic, solder glass, metal, and/or glass.

Because of the way the very small spacers (e.g., pillars) are manufactured, they are typically delivered in bulk (e.g., vials containing ~25000 pillars each, or any other suitable amount). Since the spacers must be placed individually at pre-determined locations on the glass surface during the manufacturing of the panel, this imposes a constraint of having to take one spacer at a time from a pick tray full of them. This typically involves the use of a camera, and complicated algorithms to identify each pillar on the tray and pass down the coordinates to a robot before it can be picked up and placed on the glass. In addition, it requires time consuming calibrations between the camera, the pick tray, and the robot. Such conventional techniques may suffer from one or more of the following disadvantages: (i) expensive equipment such as specialized cameras and robots for spacer picking and placing; (ii) a complex process requiring multiple time-consuming calibrations; (iii) duty cycle limitation due to interaction and data transfer latency between the cameras, PLC, and robots; (iv) limited throughput due to footprint of each robot assembly and the duty cycle limitation; and/or (v) difficult system maintenance requiring personnel with knowledge in robotics, cameras and so forth.

Certain example embodiments may solve one or more of the above problems by providing a simpler apparatus for selecting/picking and/or placing spacers during the manufacture of vacuum insulating panel(s).

In certain example embodiments, there may be provided a spacer retrieving and placement apparatus for use in retrieving and positioning spacers when manufacturing a vacuum insulating panel, the spacer retrieving and placement apparatus comprising: a slide comprising a spacer holding recess defined in a first surface thereof; a spacer holder comprising a cavity configured to hold a plurality of spacers loosely in bulk; a spacer picking and placing tool; wherein the slide is configured to reciprocate back and forth between a first position and a second position, wherein the slide is configured to retrieve a single spacer at a time from the spacer holder in the first position where the spacer holding recess of the slide is located under and/or proximate a spacer output of the spacer holder and is at least partially covered by the spacer holder, and wherein the spacer holding recess of the slide is exposed and not covered by the spacer holder in the second position; and wherein the spacer picking and placing tool is configured to pick up a single spacer at a time from the holding recess of the slide when the slide is in the second position, and to place the spacer on a substrate of the vacuum insulating panel being manufactured.

In certain example embodiments, there may be provided a spacer retrieving and placement apparatus for use in retrieving and positioning spacers when manufacturing a vacuum insulating panel, the spacer retrieving and placement apparatus comprising: a slide comprising a spacer holding recess; a spacer holder comprising a cavity configured to hold a plurality of spacers for use in the vacuum insulating panel; wherein the slide is configured to reciprocate back and forth between a first position and a second position, wherein the slide is configured to retrieve a single spacer at a time from the spacer holder in the first position where the spacer holding recess of the slide is located under and/or proximate a spacer output of the spacer holder and is at least partially covered by the spacer holder, and wherein the spacer holding recess of the slide is exposed in the second position; and wherein the slide comprises a vacuum channel defined therein, the vacuum channel being in communication with the spacer holding recess of the slide and configured to allow vacuum to be drawn via the vacuum channel to hold the spacer in the spacer holding recess of the slide during movement of the slide.

In certain example embodiments, there may be provided a method of making a vacuum insulating panel comprising a first substrate, a second substrate, a plurality of spacers provided in a gap between at least the first and second substrates, the gap at pressure less than atmospheric pressure, and a seal comprising a first seal layer; the method comprising: using a spacer retrieving and placement apparatus to retrieve and position spacers on at least one of the substrates when manufacturing the vacuum insulating panel, the spacer retrieving and placement apparatus comprising a slide comprising: a spacer holding recess, and a spacer holder comprising a cavity configured to hold a plurality of spacers for use in the vacuum insulating panel; moving the slide back and forth between a first position and a second position, wherein the slide retrieves a single spacer at a time from the spacer holder in the first position where the spacer holding recess of the slide is located under and/or proximate a spacer output of the spacer holder and is at least partially covered by the spacer holder, and wherein the spacer holding recess of the slide is exposed in the second position; and drawing a vacuum via at least a vacuum channel defined in the slide, the vacuum channel being in communication with the spacer holding recess of the slide, so as to allow the vacuum to be drawn via the vacuum channel to hold the spacer in the spacer holding recess of the slide during movement of the slide.

Technical advantage(s) may include one or more of: (i) a less complex system and/or apparatus for picking and/or placing spacers (e.g., pillars) during the manufacture of vacuum insulated panels; (ii) a system and/or apparatus for picking and/or placing spacers during the manufacture of vacuum insulating panels which can avoid or reduce the need for complex cameras, complex robots, and/or complex time-consuming calibrations; (iii) improved throughput; (iv) improved duty cycle; (v) a simpler process and/or system for picking and/or placing spacers when manufacturing vacuum insulated panels; and/or (vi) lower upfront and/or operational costs (e.g., replacing robot(s) with cheaper linear actuator(s), and/or reducing need for expensive cameras for this operation).

### BRIEF DESCRIPTION OF THE DRAWINGS

These and/or other aspects, features, and/or advantages will become apparent and more readily appreciated from the following description of various example embodiments, taken in conjunction with the accompanying drawings. Thicknesses of layers/elements, and sizes of components/elements, are not necessarily drawn to scale or in actual proportion to one another, but rather are shown as example representations. Like reference numerals may refer to like parts throughout the several views. Each embodiment herein may be used in combination with any other embodiment(s) described herein.

FIG. 1 is a perspective view of a spacer retrieving, picking and placement apparatus, for use in making a vacuum insulated panel, according to an example embodiment.

FIG. 2A is a top perspective view of the slide and spacer container, of the spacer retrieving, picking and placement apparatus of FIG. 1, with the slide in an extended position when making a vacuum insulated panel, according to an example embodiment.

FIG. 2B is a top perspective view of the slide and spacer container of FIG. 2A, of the spacer retrieving, picking and placement apparatus of FIG. 1, with the slide in a retracted position when making a vacuum insulated panel, according to an example embodiment.

FIG. 3 is a top perspective view of the slide and spacer container of FIGS. 2A-2B, of the spacer retrieving, picking and placement apparatus of FIG. 1, with the slide in an extended position when making a vacuum insulated panel and further illustrating in an exploded view a spacer holding cavity and corresponding underlying vacuum channel formed in the slide, according to an example embodiment.

FIG. 4 is a bottom perspective view of the slide of FIGS. 1-3, according to an example embodiment (vacuum channel lid not shown for clarity).

FIG. 5 is a flowchart illustrating operations involving the spacer retrieving, picking and placement apparatus of FIGS. 1-4, for example when making the vacuum insulating panel of FIGS. 6-7, according to an example embodiment.

FIG. 6 is a side cross sectional view of a vacuum insulating unit/panel according to an example embodiment.

FIG. 7 is a top plan view of the vacuum insulating panel of FIG. 6.

FIG. 8 is a flowchart illustrating example steps in making a vacuum insulating panel according to various example embodiments, which may be used in combination with any embodiment herein including those of FIGS. 1-7.

### DETAILED DESCRIPTION

The following detailed structural and/or functional description(s) is/are provided as examples only, and various alterations and modifications may be made. The example embodiments herein do not limit the disclosure and should be understood to include all changes, equivalents, and replacements within ideas and the technical scope herein. Hereinafter, certain examples will be described in detail with reference to the accompanying drawings. When describing various example embodiments with reference to the accompanying drawings, like reference numerals may refer to like components and a repeated description related thereto may be omitted.

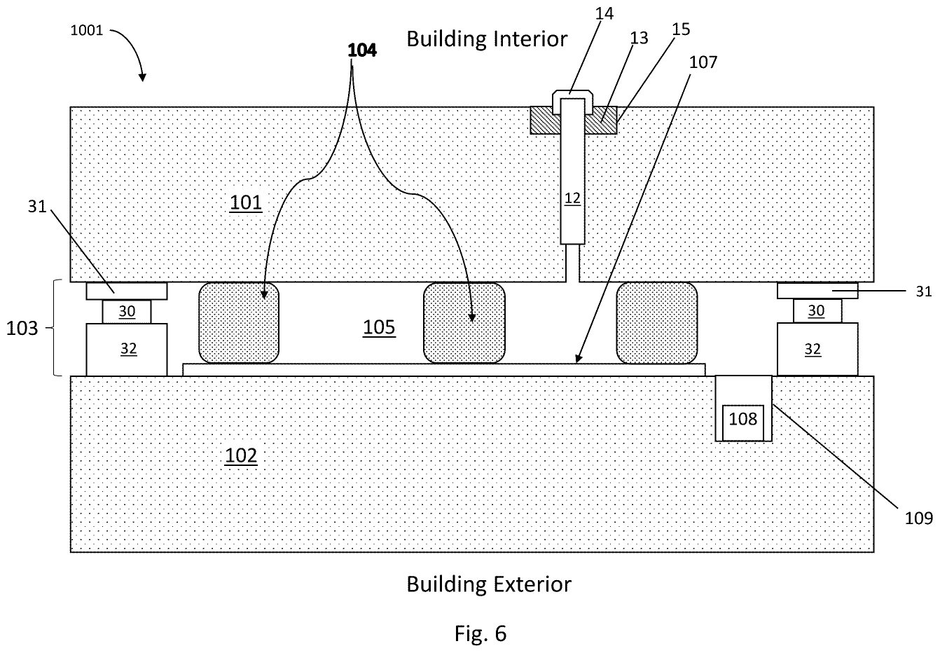

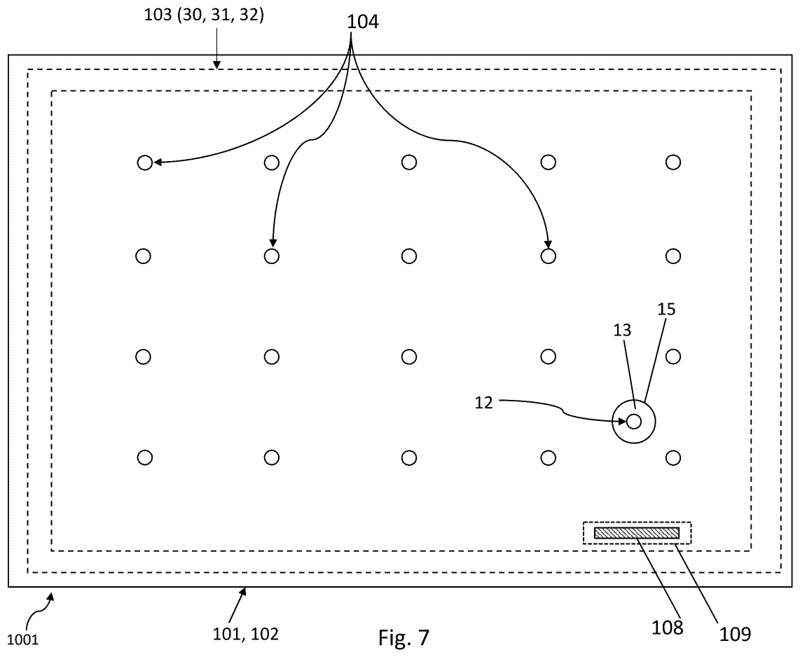

FIG. 6 is a side cross sectional view of a vacuum insulating unit/panel 1001 according to an example embodiment, for example as described in U.S. Patent Document 2024/0167324 to Thomsen, hereby incorporated herein by reference. FIG. 7 is a top plan view of the vacuum insulating panel of FIG. 6. Referring to FIGS. 6-7, for example and without limitation, an example vacuum insulating panel 1001 may include: a first substrate 101 (e.g., glass substrate), a second substrate 102 (e.g., glass substrate), a hermetic edge seal 3 at least partially provided proximate the edge of the panel 1001, and a plurality (e.g., an array) of spacers 104 provided between at least the substrates 101 and 102 for spacing the substrates from each other and so as to help provide low-pressure space/gap 105 between at least the substrates. Each glass substrate 101, 102 may be flat, or substantially flat, in certain example embodiments. Support spacers 104, sometimes referred to as pillars, may be of any suitable shape (e.g., round, oval, disc-shaped, square, rectangular, rod-shaped, etc.) and may be of or include any suitable material such as stainless steel, aluminum, ceramic, solder glass, metal, and/or glass. Certain example support spacers 104 shown in the figures are substantially circular as viewed from above and substantially rectangular as viewed in cross section, and/or may have rounded edges. The hermetic edge seal 3 may include one or more of main seal layer 30, upper primer layer 31, and lower primer layer 32. Each “layer” herein may comprise one or more layers. At least one thermal control and/or solar control coating 107, such as a multi-layer low-emittance (low-E) coating, may be provided on at least one of the substrates 101 and 102 in order to further improve insulating properties of the panel. The solar control coating 107 may be provided on substrate 101 or substrate 102, or such a solar control coating may be provided on both substrates 101 and 102. Each substrate 101 and 102 is preferably of or including glass, but may instead be of other material such as plastic or quartz. For example, one or both glass substrates 101 and 102 may be soda-lime-silica based glass substrates, borosilicate glass substrates, lithia aluminosilicate glass substrates, or the like, and may be clear or otherwise tinted/colored such as green, grey, bronze, or blue tinted. Substrates 101 and 102, in certain example embodiments, may each have a visible transmission of at least about 40%, more preferably of at least about 50%, and most preferably of from about 60-80%. An additional substrate (not shown) may also be provided if desired. The vacuum insulating panel 1001, in certain example embodiments, may have a visible transmission of at least 40%, more preferably of at least 50%, and most preferably of at least 60%. The substrates 101 and 102 may be substantially parallel (parallel plus/minus ten degrees, more preferably plus/minus five degrees) to each other in certain example embodiments. Substrates 101 and 102 may or may not have the same thickness, and may or may not be of the same size and/or same material, in various example embodiments. When glass is used for substrates 101 and 102, each of the glass substrates may be from about 1-12 mm thick, more preferably from about 3-8 mm thick, and most preferably from about 4-6 mm thick. When glass is used for substrates 101 and 102, the glass may or may not be tempered (e.g., thermally tempered). Although thermally tempered glass substrates are desirable in certain environments, the glass substrate(s) may be heat strengthened in certain example embodiments. As known in the art, thermal tempering of glass typically involves heating the glass to a temperature of at least 585 degrees C, more preferably to at least 600 degrees C, more preferably to at least 620 degrees C (e.g., to a temperature of from about 6209-650 degrees C), and then rapidly cooling the heated glass so as to compress surface regions of the glass to make it stronger. The glass substrates may be thermally tempered to increase compressive surface stress and to impart safety glass properties including small fragmentation upon breakage. When tempered glass substrates 101 and/or 102 are used, the substrate(s) may be tempered (e.g., thermally or chemically tempered) prior to firing/sintering of main edge seal material 30 (e.g., via laser) to form the edge seal 3.

Heat strengthening of the glass substrates involves the same temperature ranges as tempering, but does not include the rapid cooling/quenching. When heat strengthened glass substrates 101 and/or 102 are used, the substrate(s) may be heat strengthened prior to firing/sintering of the main edge seal material 30 (e.g., via laser) to form the edge seal 3. When a vacuum insulated glass panel/unit has one tempered glass substrate and one heat strengthened substrate, the substrate(s) may be tempered (e.g., thermally or chemically tempered) and heat strengthened prior to firing/sintering of the main edge seal material 30 (e.g., via laser) to form the edge seal 3.

In various example embodiments, each vacuum insulating panel 1001, still referring to FIGS. 6-7, optionally may also include at least one sorption getter 108 (e.g., at least one thin film getter) for helping to maintain the vacuum in low pressure space 105 by using reactive material for soaking up and/or bonding to gas molecules that remain in space 105, thus providing for sorption of gas molecules in low pressure space 105. The getter 108 may be provided directly on either glass substrate 101 or 102, or may be provided on a low-E coating 107 in certain example embodiments. In certain example embodiments, the getter 108 may be laser-activated and/or activated using inductive heating techniques, and/or may be positioned in a trough/recess 109 that may be formed in the supporting substrate (e.g., substrate 102) via laser etching, laser ablating, and/or mechanical drilling. A vacuum insulating panel 1001 may also include a pump-out tube 12 used for evacuating the space 105 to a pressure(s) less than atmospheric pressure, where the elongated pump-out tube 12 may be closed/sealed after evacuation of the space 105. Pump-out seal 13 may be provided around tube 12, and a cap 14 may be provided over the top of the tube 12 after it is sealed. After evacuation of space 105, the tip of the tube 15 may be melted via laser to seal same, and hermetic sealing of the space 105 in the panel 1001 can be provided both by the edge seal 3 and by the sealed upper portion of the pump-out tube 12 together with seal 13 and/or cap 14.

The evacuated gap/space 105 between the substrates 101 and 102, in the vacuum insulating panel 1001, is at a pressure less than atmospheric pressure. For example, after the edge seal 3 has been formed, the cavity 105 evacuated to a pressure less than atmospheric pressure, and the pump-out tube 12 closed/sealed, the gap 105 between at least the substrates 101 and 102 may be at a pressure no greater than about 1.0×10⁻² Torr, more preferably no greater than about 1.0×10⁻³ Torr, more preferably no greater than about 1.0×10⁻⁴ Torr, and for example may be evacuated to a pressure no greater than about 1.0×10⁻⁶ Torr. The gap 105 may be at least partially filled with an inert gas in various example embodiments. In certain example embodiments, the evacuated vacuum gap/space 105 may have a thickness (in a direction perpendicular to planes of the substrates 101 and 102) of from about 100-1,000 μm, more preferably from about 200-500 μm, and most preferably from about 230-350 μm. Providing a vacuum in the gap/space 105 is advantageous as it reduces conduction and convection heat transport, so as to reduce temperature fluctuations inside buildings and the like, thereby reducing energy costs and needs to heat and/or cool buildings. Thus, panels 1001 can provide high levels of thermal insulation.

Example low-emittance (low-E) coatings 7 which may be used in the vacuum insulating panel 1001 are described in U.S. Pat. Nos. 5,935,702, 6,042,934, 6,322,881, 7,314,668, 7,342,716, 7,632,571, 7,858,193, 7,910,229, 8,951,617, 9,215,760, and 10,759,693, the disclosures of which are all hereby incorporated herein by reference in their entireties. Other low-E coatings may also, or instead, be used. A low-E coating 107 typically includes at least one IR reflecting layer (e.g., of or including silver, gold, or the like) sandwiched between at least first and second dielectric layer(s) of or including materials such as silicon nitride, zinc oxide, zinc stannate, and/or the like. A low-E coating 107 may have one or more of: (i) a hemispherical emissivity/emittance of no greater than about 0.20, more preferably no greater than about 0.04, more preferably no greater than about 0.028, and most preferably no greater than about 0.015, and/or (ii) a sheet resistance (Rₛ) of no greater than about 15 ohms/square, more preferably no greater than about 2 ohms/square, and most preferably no greater than about 0.7 ohms/square, so as to provide for solar control.

Edge seal 3, which may include one or more of ceramic layers 30-32, may be located proximate the periphery or edge of the vacuum insulated panel 1001 as shown in FIGS. 6-7. Edge seal 3 may be a ceramic edge seal in certain example embodiments. Referring to FIGS. 6-7, in certain example embodiments, layer 30 of the edge seal may be considered a main and/or primary seal layer, and layers 31 and 32 may be considered primer layers. One or more of seal layers 30-32, of the edge seal 3, may be of or include ceramic frit in certain example embodiments, and/or may be lead-free or substantially lead-free (e.g., no more than about 15 ppm Pb, more preferably no more than about 5 ppm Pb, even more preferably no more than about 2 ppm Pb) in certain example embodiments.

Example materials for use in, and processes for making, the vacuum insulated panel of FIGS. 6-7 are described in U.S. Patent Document 2024/0167324 to Thomsen, hereby incorporated herein by reference. For example and without limitation, example materials, dimensions, and processes for edge seal 3, layers 30-32, spacers 104, gap 105, substrates 101-102, etc., may be found in U.S. Patent Document 2024/0167324. For example, U.S. Patent Documents 2024/0167320 and 2024/0167324 provide example descriptions of making a vacuum insulated panel which includes a tellurium oxide-based seal layer 30 and optional primer(s) 31 and/or 32, the disclosures of which are hereby incorporated herein by reference in their entireties. Other materials and/or processes may instead be used.

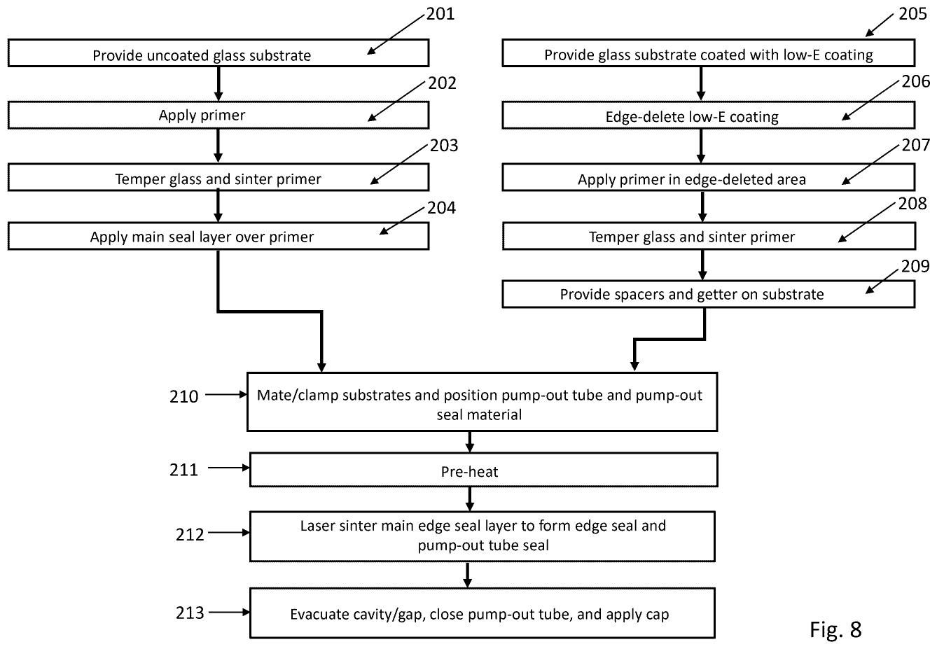

FIG. 8 is a flowchart illustrating example steps in making a vacuum insulating panel 1001 according to various example embodiments, which may be used in combination with any embodiment herein. Steps 201-204 apply to one of the two substrates, while steps 205-209 apply to the other one of the substrates, and steps 210-213 apply when the substrates are mated to each other via clamping, sealing, and/or the like. Example details may be found in U.S. Patent Document 2024/0167324 regarding various steps shown in FIG. 8. For instance, a substrate (e.g., substrate 101 in FIG. 6) is provided in step 201, and another substrate (e.g., substrate 102 in FIG. 6) is provided in step 205. The substrate in step 205 may have a low-E coating 107 provided thereon, which may be edge-deleted in step 206. A primer layer (e.g., 31) may be applied to the corresponding substrate (e.g., substrate 101) in step 202, whereas the other primer layer (e.g., 32) may be applied to the other substrate (e.g., substrate 102) in step 207. In various example embodiments, one or both ceramic sealing glass primer layers 31-32 may be boron oxide inclusive and/or bismuth oxide inclusive, and may be applied using silk screen printing, digital printing, pad printing, extrusion coating, ceramic spray coating or nozzle dispense methods. Material for primer layer(s) 31 and/or 32 may be deposited. In certain example embodiments, one or both primer layers may be applied to the glass surface at a thickness from about 40% to 60% higher than the desired target thickness. In an example embodiment, each primer layer as initially deposited may have a solids content of about 75 wt %, solvent about 24 wt. %, and binder about 1 wt. %. The substrates, with respective primers thereon, may then be thermally heated to remove solvents in the material using one of the following substrate heating methods or a combination thereof: radiation, convection, induction, microwave or conduction. The substrates may be heated between 100 degrees C to 250 degrees C for 30 seconds to ten minutes to remove the solvents from the sealing glass material with an example temperature being 180 degrees C for about 4 minutes. Substrates may then be thermally heated to remove organic resin materials in the sealing glass primer material using one of the following substrate heating methods or a combination thereof; radiation, convection, induction, microwave or conduction, such as for example to from 275 degrees C to 400 degrees C for 30 seconds to ten minutes with an example temperature being about 320 degrees C for 6 minutes. The removal of the organic resin material from the primers may be referred to as ceramic sealing glass binder burnout. In steps 203 and 208, the substrates may then be thermally heated for thermally tempering the glass substrates and to sinter and fire the ceramic primer material to the desired physical thickness and material properties using one of the following substrate heating methods or a combination thereof: radiation, convection, induction, microwave or conduction. For example, the substrates 101 and 102 may be heated to from between 575 degrees C to 700 degrees C for 30 seconds to five minutes depending on the thickness of the substrates with an example temperature being 625 degrees C at a rate of 30 seconds per mm of uncoated glass thickness and 60 second per mm of Low-E coated glass thickness. Thus, the primer layers 31-32 are fired/sintered when the corresponding glass substrates 101 and 102 are thermally tempered, in certain example embodiments, in steps 203 and 208. When heat strengthened glass is used instead of tempered glass, in certain example embodiments, the primer layers 31 and/or 32 may be sintered in a step that does not involve tempering. As an example, the primer layers may be dried at a temperature of about 180 degrees C to substantially remove solvents in the sealing glass matrix using thermal heat, and then be thermally heated a temperature of about 320 degrees C to burn out the resin binders that provide the carrier vehicle for the sealing glass paste material, and then be sintered at 625 degrees C while the glass substrates 101, 102 are thermally tempered to achieve desired properties.

In certain example embodiments, in steps 203 and 208, the primer layers 31 and 32 may bond to and/or diffuse into the respective glass substrates upon which they are located since the glass substrates 101, 102 are above the glass softening point, and create a high adhesion strength to the glass substrates. Interdiffusion of the primer layer(s) into the respective glass substrate(s) results in a high adhesion strength to the glass substrates, as for example SiO₂ in the primer layer(s) bond to a silicon-rich layer in a soda lime silicate float glass in certain example embodiments.

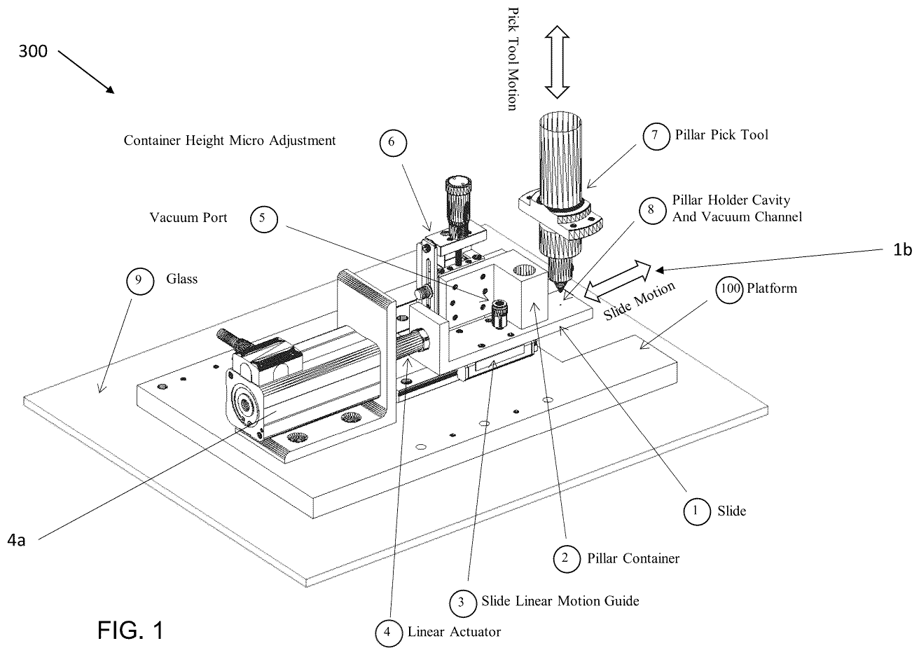

Spacers 104 are placed on one of the substrates (101 or 102) in step 209. The spacer retrieving, picking and placement apparatus of FIGS. 1-5 may be used to pick and place the spacers 104 onto a substrate (101 or 102) in step 209.

In step 204, paste for forming ceramic sealing glass main layer 30 (e.g., which may be Te oxide based or inclusive as discussed above) may then applied to one of the glass substrates over the primer layer (e.g., over primer 31, or over primer 32), such as via silkscreen printing, ceramic spray, extrusion coating, digital printing, pad printing, extrusion, nozzle dispense or other commercially available ceramic sealing material application methods. As mentioned above, the paste may include glass, filler, solvent, and binder. The substrate may be thermally heated to remove solvents in the material using one of the following substrate heating methods or a combination thereof; radiation, convection, induction, microwave and/or conduction. The substrate may be heated between 100 degrees C to 250 degrees C for 30 seconds to ten minutes to remove solvents from the material with an example temperature being about 180 degrees C for about 4 minutes.

After the spacers 104 are provided on a substrate in step 209, the two glass substrates 101 and 102 may then be mated together and clamped around the periphery of the vacuum insulated unit to create a mated unit in step 210. The pump-out tube 12 and preform 13 may be applied to the substrate having recess 15 between steps 210 and 211 in certain example embodiments. The mated unit may then be thermally heated to burn out the resin binders that provide the carrier vehicle for the sealing glass paste material and then pre-glazed at a temperature of about 370 degrees C to impart mechanical strength properties and performance between the main layer and primer layer(s). For example, mechanical adhesion strength after the mated unit has been pre-glazed may be about 30 kg per cm² and can be up to 100 kg per cm². For example, the perimeter of the vacuum insulated glass unit may be physically clamped with a controlled pressure to assist in setting the final thickness/height of the edge seal 3. The substrates may then be thermally heated to remove organic resin materials in the paste using one of the following substrate heating methods or a combination thereof; radiation, convection, induction, microwave or conduction. The binder burnout duration may be optimized so that much or substantially all binder is removed from the main layer 30 and the target density and/or porosity may be achieved. The mated unit may be heated to about 370 degrees C to pre-glaze in certain example embodiments. The pre-glaze may one or more of: (1) create a strong mechanical bond between the primer layer(s) and the main seal layer; (2) the main seal layer may reach or substantially reach its target thickness so the mechanical clamps may be removed prior to laser sintering; and/or (3) reduce process requirements for the laser to enable high linear rates.

In step 211, the mated unit may be pre-heated. In step 212, a laser (e.g., an 800 nm, 808 nm, 810 nm, or 940 nm continuous wave laser) may then be used to locally and selectively sinter/fire the material for the main seal layer 30. In step 213, the vacuum insulating panel is then evacuated to a low pressure using the pump-out tube 12, the tube closed off, and a cap 14 may be applied thereto.

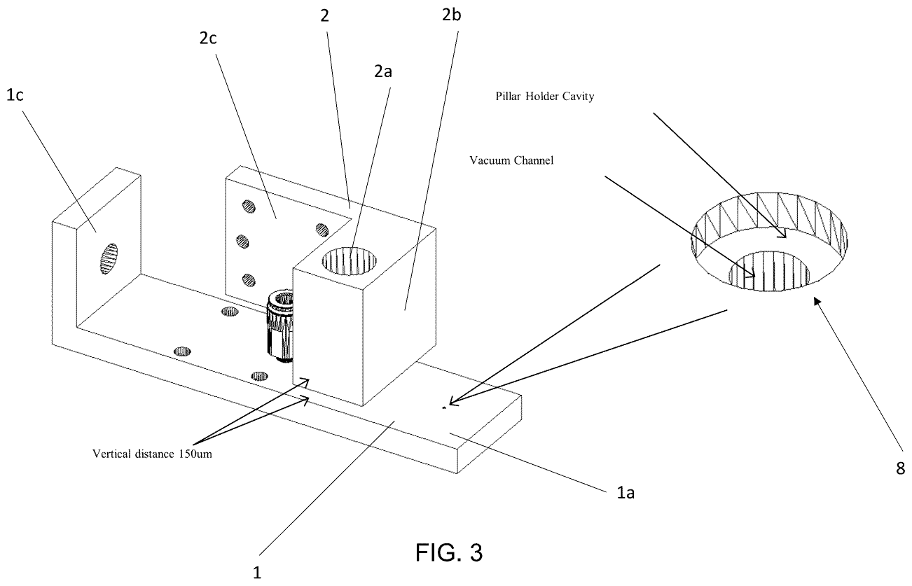

FIGS. 1-5 illustrate a spacer retrieving, picking and placement apparatus 300 that may be used to access (e.g., select and/or pick) and place the spacers 104 onto a substrate 9 (substrate 101 or 102) in step 209, according to an example embodiment. FIG. 1 is a perspective view of a spacer accessing and placement apparatus 300, for use in making a vacuum insulated panel 1001, according to an example embodiment. The spacer accessing and placement apparatus 300 is configured to be positioned over substrate 9 (e.g., substrate 101 or 102 in FIGS. 6-7) on which the spacers 104 are to be placed, and the apparatus 300 may include one or more of slide 1, container 2 for holding a plurality (e.g., tens, hundreds, and/or thousands) of spacers 104, slide linear motion guide 3, linear actuator 4, vacuum port 5, container height micro adjustment system 6, spacer picking/placing tool 7, and platform 100 which may support one or more of components 1-7. The apparatus 300 allows for automatically feeding a single spacer (e.g., pillar) 104 at a time out to the pick tool head 7 in a simple way, without the need for expensive cameras and robots. Tool 7 and head thereof may be of any suitable shape. Thus, a given pick tool head 7 may pick up one spacer 1004 at a time, and place one spacer 104 at a time onto the substrate 9 (e.g., substrate 101 or 102 in FIGS. 6-7). Spacer picking/placing tool 7, as shown, may comprise a head for picking up spacers from the slide and may have a vacuum cavity communication with the head in order to use a vacuum to help the head of the tool 7 pick up spacers from the slide cavity 8. The size of a picking portion of the head is to accommodate a single spacer 104. The head of the tool 7 may have a spacer receiving cavity defined therein similar to that shown for cavity 8 in FIG. 3, and vacuum applied to the tool may be used to maintain the spacer 104 in the tool head cavity during picking and transport to the panel substrate. In addition to significantly reducing machine cost and/or complexity, this design, having a small footprint, also may allow the addition of multiple heads 7 working simultaneously for substantial throughput increase in placing spacers 104 onto the substrate 9/102 (e.g., see spacers 104 on a glass substrate 102 of the vacuum insulating panel 1001 in FIG. 6).

FIG. 1, illustrating an example embodiment, shows the physical structure of the spacer retrieving, picking and placement apparatus 300 including platform 100 which supports other compounds such as via mounting or in any other suitable manner. Platform 100 of the apparatus 300 may be positioned on, or held slightly above, the substrate 9 (e.g., 101 or 102) on which the spacers 104 are to be placed. Apparatus 300 further may include slide 1, spacer holder cavity/recess 8 defined in the slide 1 which is configured to retrieve a single spacer (e.g., pillar) 104 at a time from the spacer container 2. Spacer container 2 includes a cavity and is configured to hold spacers 104 loosely in bulk (e.g., hundreds or thousands of spacers 104 in the cavity of the holder/container 2). Linear slide linear motion guide 3 and linear actuator 4 of the apparatus 300 are configured to cause precise back and forth reciprocal motion of the slide 1 under the container 2. Vacuum port 5 aids in the selection of a single spacer 104, and container height micro adjustment 6 is configured to allow precise adjustments of the container 2 floating distance over the slide 1 thereby allowing only one spacer 104 in the holder hole to exit the container 2 at a time and be positioned in spacer holder cavity/recess 8. When the slide 1, with the spacer 104 thereon in the cavity/recess 8, slides back out toward tool 7 the pick tool 7 then picks up the single spacer 104 from the holder hole/cavity/recess 8 on the slide and places it on the substrate 9 (e.g., substrate 101 or 102 in FIGS. 6-7) when the slide 1 moves away to retrieve another spacer 104.

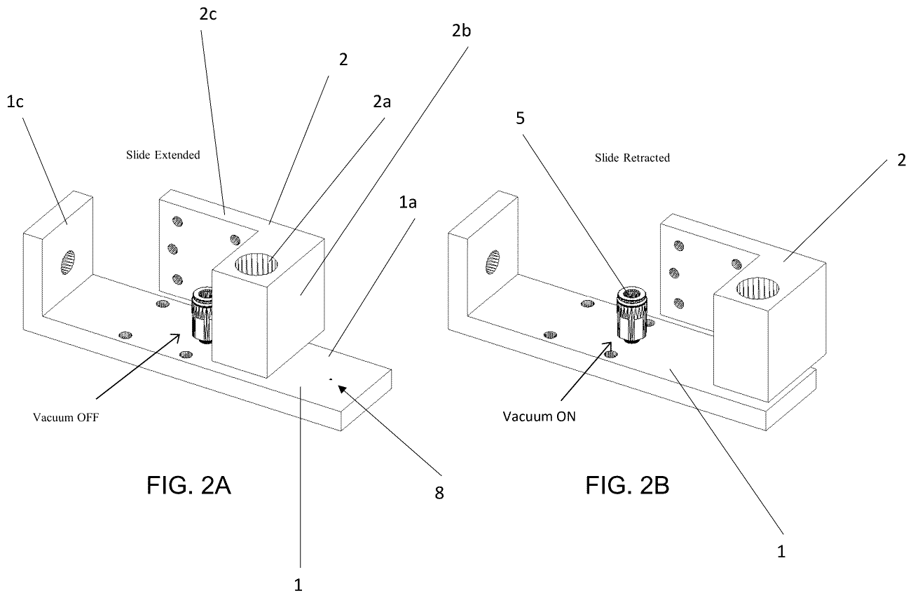

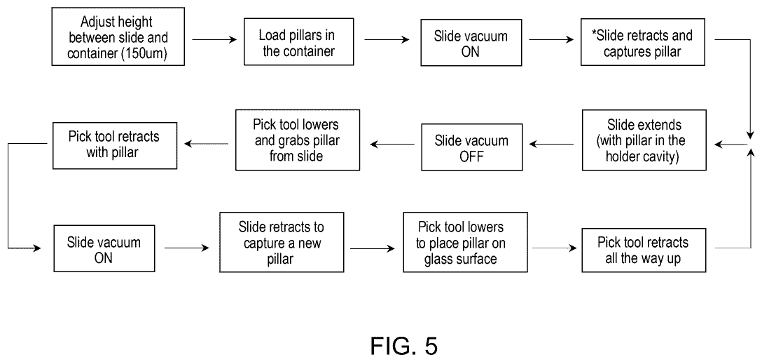

FIG. 2A is a top perspective view of the slide 1 and spacer container 2, of the spacer retrieving, picking and placement apparatus of FIG. 1, with the slide 1 in an extended position when making a vacuum insulated panel, according to an example embodiment. Spacers 104 may be loaded into the spacer container 2 via hole 2a in certain example embodiments, which hole 2a is part of and/or in communication with a cavity of the container/holder 2 for housing/holding spacers 104. FIG. 2B is a top perspective view of the slide 1 and spacer container 2 of FIGS. 1 and 2A, with the slide 1 in a retracted position when making a vacuum insulated panel, according to an example embodiment. Thus, FIG. 2B illustrates a retracted position of the slide 1, where the slide 1 has been slid from its FIG. 1 position (slid to the left as viewing FIG. 1) to the FIG. 2B position so as to retrieve a spacer 104 from the holder 2 when the holder cavity/recess 8 defined in the slide is under the spacer output of the spacer holder 2. The spacer holding recess 8 is covered by the spacer holder/container 2 in the FIG. 2B position, as shown. Removable vacuum port 5, configured to have a vacuum hose (not shown, with the hose being connected to a vacuum) connected thereto, allows a vacuum to be drawn via spacer holder cavity/recess 8 thereby allowing a spacer 104 from the holder 2 to be sucked into and/or held in spacer holder cavity/recess 8 of the slide 1. The vacuum is configured to be ON when the slide 1 is in the FIG. 2B position retrieving a spacer 104 from the holder 2 (when the spacer holder cavity/recess 8 is under the spacer output of container 2) and while the slide 1 is moved back toward the FIG. 2A position, and is configured to be OFF when the slide 1 is in the FIG. 2A position so that the picking tool 4 can pick up the spacer 104 from the slide 1 (e.g., see FIG. 5). After a single spacer 104 is retrieved/positioned in the holder cavity/recess 8 when the slide 1 is in the FIG. 2B position when the vacuum is ON, the slide 1 is slid/moved to the FIG. 2A position (to the right when viewing FIG. 1) with the vacuum still ON so that the spacer 104 is exposed, and then after the vacuum is turned OFF the spacer 104 in cavity/recess 8 can be picked up by the spacer picking tool 7 as shown in FIG. 1 and the tool 7 can place that spacer 104 onto the substrate 9 after the slide 9 is moved back to the left to its FIG. 2B position to retrieve another spacer 104. As shown in FIGS. 1 and 2A-2B, slide 1 may be substantially L-shaped in certain example embodiments, with the major planar surface 1a of the slide having the spacer holder cavity/hole 8 at least partially defined therein and being configured to slide in a plane in reciprocating opposite directions 1b so as to slide back and forth under the spacer holder 2 and spacer picking tool 7. As shown in FIGS. 1-2, wall 1c of the slide 1, which may be substantially perpendicular to major surface 1a of the slide, may be configured to be attached to linear actuator 4 which may include a rod that can be pushed/pulled by a motor 4a (e.g., hydraulic or electric motor) in order to cause slide 1 to slide back and forth in opposite slide directions 1b. Spacer holder 2 may also be substantially L-shaped in certain example embodiments, as shown in FIGS. 1-2, with hole 2a being formed in relatively thick holding wall 2b which includes a cavity defined therein for housing the spacers 104 in bulk. Support wall 2c of the spacer holder 2, which may be substantially perpendicular to wall 2b, may be configured to support wall 2b and allow the holder 2 to be connected to height micro adjustment system 6 which allows the holder 2 to be moved up/down in very small increments in order to control the floating distance of the container 2 over the slide 1 thereby allowing only one spacer 104 at a time to exit holder/container 2 and be positioned in spacer holder cavity/recess 8 of the slide. If this floating distance were to be too great, multiple spacers at a time would spill out of the holder 2, and if it were too small retrieved spacers could not be reasonably moved toward the picker under the holder 2 while in cavity/recess 8 of the slide 1. Height micro adjustment system 6 may include a motor (e.g. hydraulic or electric motor) connected, directly or indirectly, to support wall 2c of the spacer holder 2. Reciprocating slide 1 and container 2 may be of any suitable shape, and may be made of stainless steel, aluminum, metal, and/or any other suitable material.

FIG. 3 is a top perspective view of the slide 1 and spacer container 2 of FIGS. 1 and 2A-2B, of the apparatus 300, with the slide 1 in an extended position when making a vacuum insulated panel and further illustrating in an exploded view an example spacer holding cavity/recess 8 defined in a the slide and corresponding underlying vacuum channel formed in the slide 1, according to an example embodiment. FIG. 3 provides an exploded close-up view of the spacer holding cavity/recess 8 according to an example embodiment. The spacer 104, retrieved from the holder 2, is held in place in cavity/recess 8 via sucking action of the vacuum via the illustrated vacuum channel under the cavity/recess 8. Cavity/recess 8 may be configured so that a retrieved spacer 104 therein may, or may not, stick up above the major surface of the slide 1 during slide movement. It is noted that spacers 104 may be substantially dime-shaped and/or disc-shaped in certain example embodiments, similar to the shape of the slightly larger recess shown in FIG. 3 for cavity/recess 8. FIG. 3 also illustrates an example vertical floating distance of about 150 μm which may be provided between the upper surface of the slide 1 and the bottom surface of the holder 2. As explained above, this floating distance is to be controlled thereby allowing only one spacer 104 at a time to exit holder/container 2 and be positioned in spacer holder cavity/recess 8 of the slide. If this floating distance were to be too great, multiple spacers at a time would spill out of the holder 2, and if it were too small then retrieved spacers could not be reasonably moved toward the picker under the holder 2 while in cavity/recess 8 of the slide 1. This floating distance, between the holder 2 and slide 1, may be from about 100-200 μm in certain example embodiments, more preferably from about 130-180 μm, and most preferably from about 140-160 μm. Thus, the adjustment system 6, slide 1, and holder 2 may be configured to control the distance between the slide 1 and holder/container 2 so that a bottom planar surface of the holder/container 2 can be positioned over and above a top planar surface of the slide 1 at at least one elevation in a range of from about 100-200 μm, more preferably at at least one elevation in a range of from about 130-180 μm, and most preferably at at least one elevation in a range of from about 140-160 μm, to allow spacers to drop from the holder into the cavity/recess 8 and so that the slide can then move the spacer to a position under the picker, without excess spacers falling from the holder. Considering that vacuum is being applied under the spacer holder cavity/recess 8, and the large number of spacers (e.g., pillars) in the container (e.g., ~20,000), the spacer holder cavity/recess 8 is configured so that it can hold only one spacer 104 at a time. The spacer dimensions (e.g., cylinder about 500 μm in diameter, about 250 μm tall), and the vertical separation between the slide and the container (e.g., about 150 μm), are taken into account when designing the size and shape of the cavity/recess 8 so that there is a very high probability that only a single spacer 104 (e.g., pillar) will be captured by the holder cavity/recess 8 each time the slide moves to the FIG. 2B position for spacer retrieval.

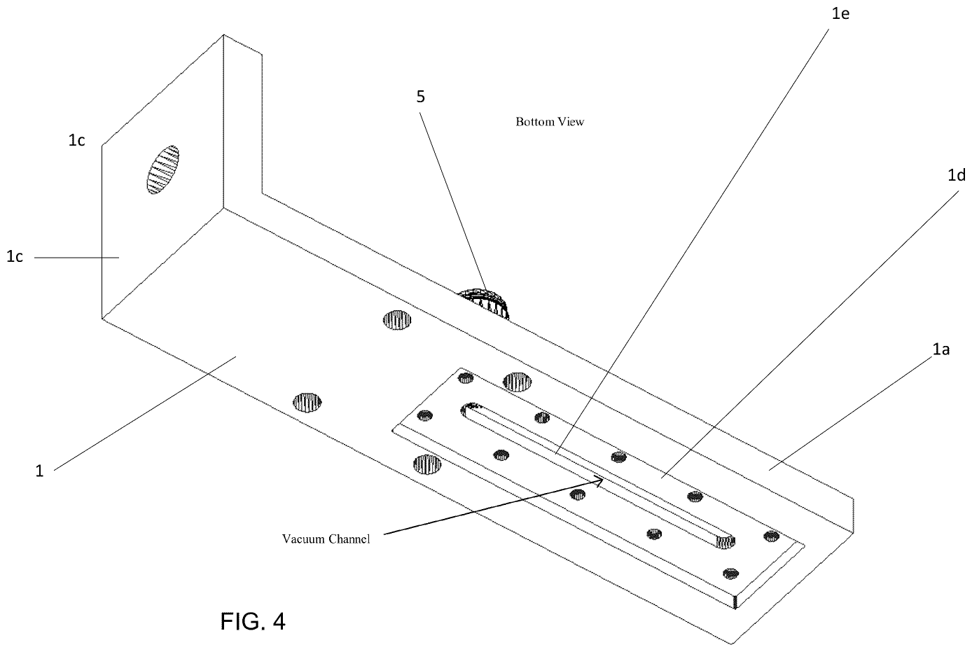

FIG. 4 is a bottom perspective view of the slide 1 of FIGS. 1-3, according to an example embodiment. FIG. 4 illustrates an example vacuum channel 1e defined in the slide 1, where the vacuum channel 1e communicates between the cavity/recess 8 and the removable vacuum port 5 thereby allowing the vacuum (not shown) connected to the port 5 to draw a vacuum via the illustrated vacuum channel 1e and holder cavity/recess 8 in order to suck a spacer 104 from the bulk holder 2 into the cavity/recess 8 and hold it there using the vacuum. FIG. 4 illustrates an example embodiment where a rectangular recess 1d is formed in the bottom surface of the slide 1, and vacuum channel 1e is formed in a bottom of the recess 1d. The vacuum channel 1e illustrated in FIG. 4 is part of and/or communications with the vacuum channel shown in FIG. 3 at the bottom of spacer holding cavity/recess 8. It will be appreciated that a cover (not shown) is to be provided in recess 1d over the illustrated vacuum channel 1e defined in the body of the slide 1 in order to seal the vacuum channel 1e from ambient atmosphere so that sufficient vacuum can be drawn to holder spacers in cavity/recess 8.

FIG. 5 is a flowchart illustrating operations involving the spacer retrieving, picking and placement apparatus 300 of FIGS. 1-4, for example when placing spacers 104 on substrate 102 in step 209 (see FIG. 8) during the manufacture of the vacuum insulating panel 1001 of FIGS. 6-7, according to an example embodiment. Referring to FIG. 5, and to other appropriate figures, holder height adjustment 6 initially adjusts the height of the holder/container 2 over the slide 1 as discussed above, for example to a floating height of about 150 μm. Spacers 104 are loaded into the holding cavity of the spacer container/holder 2, so that for example hundreds and/or thousands of spacers are loosely held in the cavity of the container/holder 2 (the cavity has a small lower opening for spacers 104 to drop from the container into cavity/recess 8 of the slide 1 when appropriate). The vacuum is then turned ON. The actuator 4, 4a then causes the slide 1 to slide/retract/move to the FIG. 2B position so that the cavity/recess 8 in the slide is located under the spacer output of holder/container 2, so that a single spacer 104 drops and/or is sucked from the container 2 output port and becomes positioned in cavity/recess 8 of the slide and held there by the vacuum and the walls of the cavity/recess 8. The actuator 4, 4a then causes the slide 1 to slide/retract/move, with the spacer 104 in cavity/recess 8, to the FIG. 2A position. When the slide reaches the FIG. 2A position, the vacuum is turned OFF and the picking/placing tool 7 (which may also use a vacuum, and/or mechanical grabbing) picks up the spacer 104 from cavity/recess 8 of the slide 1. After the picking/placing tool 7 holding the single spacer 104 moves away from the slide 1, the vacuum can be turned back ON and the slide 1 again moved from the FIG. 2A position to the FIG. 2B position. When the slide 1 is retrieving another spacer, the picking/placing tool 7 can then be lowered and place the spacer 104 it is holding in an appropriate position on the substrate 9 (e.g., substrate 102) of the panel (e.g., see spacer 104 positions in FIGS. 6-7). One or more spacer retrieving, picking and placement apparatuses 300 may work simultaneously on a panel, so that spacers can be placed on the substrate faster when multiple apparatuses 300 are working on the panel at the same time. After a spacer 104 has been placed on the substrate 9, the picking/placing tool 7 can be retracted so that it can later pick up another spacer from the slide. This process may be repeated until an appropriate array of spacers 104 is provided on the substrate 9 (e.g., 101 or 102). One or more of the steps shown in FIG. 5 may be omitted in certain example embodiments, and/or other steps may be added.

In an example embodiment, there may be provided a spacer retrieving and placement apparatus (e.g., 300) for use in retrieving and positioning spacers (e.g., 104) when manufacturing a vacuum insulating panel (e.g., 1001), the spacer retrieving and placement apparatus (e.g., 300) comprising: a slide (e.g., 1) comprising a spacer holding recess (e.g., 8) defined in a first surface (e.g., 1a) thereof; a spacer holder (e.g., 2) comprising a cavity configured to hold a plurality of spacers (e.g., 104) loosely in bulk; a spacer picking and placing tool (e.g., 7); wherein the slide (e.g., 1) is configured to reciprocate back and forth between a first position (e.g., see FIG. 2B) and a second position (e.g., see FIG. 2A), wherein the slide (e.g., 1) is configured to retrieve a single spacer at a time from the spacer holder in the first position (e.g., see FIG. 2B) where the spacer holding recess (e.g., 8) of the slide (e.g., 1) is located under and/or proximate a spacer output of the spacer holder (e.g., 2) and is at least partially covered by the spacer holder (e.g., 2), and wherein the spacer holding recess (e.g., 8) of the slide is exposed and not covered by the spacer holder (e.g., 2) in the second position (e.g., see FIG. 2A); and wherein the spacer picking and placing tool (e.g., 7) is configured to pick up a single spacer (e.g., 104) at a time from the holding recess (e.g., 8) of the slide when the slide is in the second position, and to place the spacer on a substrate (e.g., 9, 101, or 102) of the vacuum insulating panel (e.g.,, 1001) being manufactured.

In the spacer retrieving and placement apparatus of the preceding paragraph, the slide (e.g., 1) may comprise a vacuum channel defined therein, the vacuum channel being in communication with the spacer holding recess of the slide and configured to allow vacuum to be drawn via the vacuum channel to hold the spacer in the spacer holding recess of the slide.

In the spacer retrieving and placement apparatus of any of the preceding two paragraphs, the spacer holding recess of the slide may be sized to hold only a single spacer.

In the spacer retrieving and placement apparatus of any of the preceding three paragraphs, the spacer picking and placing tool may comprise a head and a vacuum channel and/or cavity, and may be configured so that a vacuum can be drawn via the vacuum channel and/or cavity to hold the spacer in the head of the tool.

In the spacer retrieving and placement apparatus of any of the preceding four paragraphs, the slide, the spacer holder, and/or the spacer picking and placing tool may be configured so that spacers can be retrieved from the spacer holder by the slide and picked up from the slide by the picking and placing tool without assistance from any camera.

In the spacer retrieving and placement apparatus of any of the preceding five paragraphs, the slide and/or the spacer holder may be configured so that spacers can be retrieved from the spacer holder by the slide without assistance from any camera and/or robot.

The spacer retrieving and placement apparatus of any of the preceding six paragraphs may further comprise a height adjustment system configured to adjust a height of the spacer holder over the slide. The height adjustment system may be configured to adjust the height of the spacer holder over the slide to at least one height in a range of from about 100-200 μm, more preferably to at least one height in a range of from about 130-180 μm.

In the spacer retrieving and placement apparatus of any of the preceding seven paragraphs, the slide and the spacer holder may be configured so that a bottom surface of the spacer holder can be positioned and held over a top surface of the slide and spaced therefrom by at least one elevation in a range of from about 100-200 μm (more preferably to at least one height in a range of from about 130-180 μm, more preferably to at least one height in a range of from about 140-160 μm) to allow spacers to drop one at a time from the spacer holder into the spacer holding recess when the slide is in the first position and so that the slide can then move the spacer in the spacer holding recess to the second position, without excess spacers falling from the spacer holder.

The spacer retrieving and placement apparatus of any of the preceding eight paragraphs may further comprise a linear actuator configured to move the slide back and forth between the first and second positions.

In the spacer retrieving and placement apparatus of any of the preceding nine paragraphs, the slide may be substantially L-shaped.

In the spacer retrieving and placement apparatus of any of the preceding ten paragraphs, the spacer holder may be substantially L-shaped. The spacer holder may comprise first and second walls that are substantially perpendicular to each other, the first wall overlapping at least part of the slide and the second wall not overlapping the slide.

In the spacer retrieving and placement apparatus of any of the preceding eleven paragraphs, the spacer holding recess and a vacuum port may both provided at least partially at the first surface of the slide.

It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). Terms, such as “first”, “second”, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component. “Or” as used herein may cover both “and” and “or.”

It should be noted that if it is described that one component is “connected”, “coupled”, or “joined” to another component, at least a third component(s) may be “connected”, “coupled”, and “joined” between the first and second components, although the first component may be directly connected, coupled, or joined to the second component. Thus, terms such as “connected” and “coupled” cover both direct and indirect connections and couplings.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The word “about” as used herein means the identified value plus/minus 5%.

“On” as used herein covers both directly on, and indirectly on with intervening element(s) therebetween. Thus, for example, if element A is stated to be “on” element B, this covers element A being directly and/or indirectly on element B. Likewise, “supported by” as used herein covers both in physical contact with, and indirectly supported by with intervening element(s) therebetween.

Each embodiment herein may be used in combination with any other embodiment(s) described herein.

While the disclosure has been illustrated and described with reference to various example embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in combination with any other embodiment(s) described herein.

1. A spacer retrieving and placement apparatus for use in retrieving and positioning spacers when manufacturing a vacuum insulating panel, the spacer retrieving and placement apparatus comprising:
a slide comprising a spacer holding recess defined in a first surface thereof;
a spacer holder comprising a cavity configured to hold a plurality of spacers loosely in bulk;
a spacer picking and placing tool;
wherein the slide is configured to reciprocate back and forth between a first position and a second position, wherein the slide is configured to retrieve a single spacer at a time from the spacer holder in the first position where the spacer holding recess of the slide is located under and/or proximate a spacer output of the spacer holder and is at least partially covered by the spacer holder, and wherein the spacer holding recess of the slide is exposed and not covered by the spacer holder in the second position; and
wherein the spacer picking and placing tool is configured to pick up a single spacer at a time from the holding recess of the slide when the slide is in the second position, and to place the spacer on a substrate of the vacuum insulating panel being manufactured.

2. The spacer retrieving and placement apparatus of claim 1, wherein the slide comprises a vacuum channel defined therein, the vacuum channel being in communication with the spacer holding recess of the slide and configured to allow vacuum to be drawn via the vacuum channel to hold the spacer in the spacer holding recess of the slide.

3. The spacer retrieving and placement apparatus of claim 2, wherein the spacer holding recess of the slide is sized to hold only a single spacer.

4. The spacer retrieving and placement apparatus of claim 1, wherein the spacer picking and placing tool comprises a head and a vacuum channel and/or cavity, and is configured so that a vacuum can be drawn via the vacuum channel and/or cavity to hold the spacer in the head of the tool.

5. The spacer retrieving and placement apparatus of claim 1, wherein the slide, the spacer holder, and the spacer picking and placing tool are configured so that spacers can be retrieved from the spacer holder by the slide and picked up from the slide by the picking and placing tool without assistance from any camera.

6. The spacer retrieving and placement apparatus of claim 1, wherein the slide and the spacer holder are configured so that spacers can be retrieved from the spacer holder by the slide without assistance from any camera and/or robot.

7. The spacer retrieving and placement apparatus of claim 1, further comprising a height adjustment system, comprising a motor and/or actuator, configured to adjust a height of the spacer holder over the slide.

8. The spacer retrieving and placement apparatus of claim 7, wherein the height adjustment system is configured to adjust the height of the spacer holder over the slide to at least one height in a range of from about 100-200 μm.

9. The spacer retrieving and placement apparatus of claim 1, wherein the slide and the spacer holder are configured so that a bottom surface of the spacer holder can be positioned and held over a top surface of the slide and spaced therefrom by at least one elevation in a range of from about 100-200 μm, to allow spacers to drop one at a time from the spacer holder into the spacer holding recess when the slide is in the first position and so that the slide can then move the spacer in the spacer holding recess to the second position, without excess spacers falling from the spacer holder.

10. The spacer retrieving and placement apparatus of claim 1, wherein the slide and the spacer holder are configured so that a bottom surface of the spacer holder can be positioned and held over a top surface of the slide and spaced therefrom by at least one elevation in a range of from about 130-180 μm, to allow spacers to drop one at a time from the spacer holder into the spacer holding recess when the slide is in the first position and so that the slide can then move the spacer in the spacer holding recess to the second position, without excess spacers falling from the spacer holder.

11. The spacer retrieving and placement apparatus of claim 1, wherein the slide and the spacer holder are configured so that a bottom surface of the spacer holder can be positioned and held over a top surface of the slide and spaced therefrom by at least one elevation in a range of from about 140-160 μm, to allow spacers to drop one at a time from the spacer holder into the spacer holding recess when the slide is in the first position and so that the slide can then move the spacer in the spacer holding recess to the second position, without excess spacers falling from the spacer holder.

12. The spacer retrieving and placement apparatus of claim 1, further comprising a linear actuator, comprising a motor, configured to move the slide back and forth between the first and second positions.

13. The spacer retrieving and placement apparatus of claim 1, wherein the slide is substantially L-shaped.

14. The spacer retrieving and placement apparatus of claim 1, wherein the spacer holder is substantially L-shaped.

15. The spacer retrieving and placement apparatus of claim 14, wherein the spacer holder comprises first and second walls that are substantially perpendicular to each other, the first wall overlapping at least part of the slide and the second wall not overlapping the slide.

16. The spacer retrieving and placement apparatus of claim 1, wherein the spacer holding recess and a vacuum port are both provided at least partially at the first surface of the slide.

17. A spacer retrieving and placement apparatus for use in retrieving and
positioning spacers when manufacturing a vacuum insulating panel, the spacer retrieving and placement apparatus comprising:
a slide comprising a spacer holding recess;
a spacer holder comprising a cavity configured to hold a plurality of spacers for use in the vacuum insulating panel;
wherein the slide is configured to reciprocate back and forth between a first position and a second position, wherein the slide is configured to retrieve a single spacer at a time from the spacer holder in the first position where the spacer holding recess of the slide is located under and/or proximate a spacer output of the spacer holder and is at least partially covered by the spacer holder, and wherein the spacer holding recess of the slide is exposed in the second position; and
wherein the slide comprises a vacuum channel defined therein, the vacuum channel being in communication with the spacer holding recess of the slide and configured to allow vacuum to be drawn via the vacuum channel to hold the spacer in the spacer holding recess of the slide during movement of the slide.

18. The spacer retrieving and placement apparatus of claim 17, wherein the spacer holding recess of the slide is sized to hold only a single spacer.

19. The spacer retrieving and placement apparatus of claim 17, further comprising a spacer picking and placing tool comprising a head and a vacuum channel and/or cavity, configured to pick up the spacer from the slide and hold the spacer in the head of the tool.

20. The spacer retrieving and placement apparatus of claim 17, wherein the slide and the spacer holder are configured so that spacers can be retrieved from the spacer holder by the slide without assistance from any camera and/or robot.

21. The spacer retrieving and placement apparatus of claim 17, wherein the slide and the spacer holder are configured so that a bottom surface of the spacer holder can be positioned and held over a top surface of the slide and spaced therefrom by at least one elevation in a range of from about 100-200 μm, to allow spacers to drop one at a time from the spacer holder into the spacer holding recess when the slide is in the first position and so that the slide can then move the spacer in the spacer holding recess to the second position, without excess spacers falling from the spacer holder.

22. The spacer retrieving and placement apparatus of claim 17, wherein the slide and the spacer holder are configured so that a bottom surface of the spacer holder can be positioned and held over a top surface of the slide and spaced therefrom by at least one elevation in a range of from about 130-180 μm.

23. The spacer retrieving and placement apparatus of claim 17, wherein the slide and the spacer holder are configured so that a bottom surface of the spacer holder can be positioned and held over a top surface of the slide and spaced therefrom by at least one elevation in a range of from about 140-160 μm.

24. The spacer retrieving and placement apparatus of claim 17, wherein the spacer holder comprises first and second walls that are substantially perpendicular to each other, the first wall overlapping at least part of the slide and the second wall not overlapping the slide.

25. A method of making a vacuum insulating panel comprising a first substrate, a second substrate, a plurality of spacers provided in a gap between at least the first and second substrates, the gap at pressure less than atmospheric pressure, and a seal comprising a first seal layer; the method comprising:
using a spacer retrieving and placement apparatus to retrieve and position spacers on at least one of the substrates when manufacturing the vacuum insulating panel, the spacer retrieving and placement apparatus comprising a slide including: a spacer holding recess, and a spacer holder comprising a cavity configured to hold a plurality of spacers for use in the vacuum insulating panel;
moving the slide back and forth between a first position and a second position, wherein the slide retrieves a single spacer at a time from the spacer holder in the first position where the spacer holding recess of the slide is located under and/or proximate a spacer output of the spacer holder and is at least partially covered by the spacer holder, and wherein the spacer holding recess of the slide is exposed in the second position; and
drawing a vacuum via at least a vacuum channel defined in the slide, the vacuum channel being in communication with the spacer holding recess of the slide, so as to allow the vacuum to be drawn via the vacuum channel to hold the spacer in the spacer holding recess of the slide during movement of the slide.
